(19) United States
(12) Patent Application Publication
(10) Pub. No.: US 2024/0092517 A1
(43) Pub. Date: Mar. 21, 2024

(54) MULTI-STAGE PRESSURE SEALING OF METALLIZED SUBSTRATES

(71) Applicant: SOCIETE DES PRODUITS NESTLE S.A., Vevey (CH)

(72) Inventors: KIAT HWEE YEO, Singapore (SG); HOCK SENG GORDON SOH, Singapore (SG); SHEIK ABDULLAH ALLAPICHAI, Lausanne (CH)

(21) Appl. No.: 18/255,387

(22) PCT Filed: Nov. 17, 2021
(86) PCT No.: PCT/EP2021/081975

§ 371 Date: Jun. 1, 2023

(30) Foreign Application Priority Data
Dec. 2, 2020 (SG) 10202012013W
Feb. 18, 2021 (EP) 21157738.2

(51) Int. Cl. B65B 51/14; B29C 65/00; B65B 51/30

(52) U.S. Cl. CPC B65B 51/146; B29C 66/72321; B65B 51/30

(57) ABSTRACT

The invention relates to a sealing tool (100) with a sealing surface (110) for sealing sheets (200) of metallized substrate, such as metallized paper or metallized plastic material, in cooperation with a sealing tool counterpart (190), which is arranged opposite to the sealing tool (too) with respect to the sheets (200) that are to be sealed. The sealing surface (no) comprises a plurality of sealing sections (111-115), which all face in the same sealing direction (SD) of the sealing tool (100), and has a sealing width extending transversely to the sealing direction (SD) of the sealing tool (100) from an outer sealing tool side (121) to an inner sealing tool side (122). The sealing sections (111-115) are arranged side by side in a stepwise manner so that, from the outer sealing tool side (121) to the inner sealing tool side (122), every sealing section (111-115) is offset from its neighbouring sealing section (111-115) in a direction opposite to the sealing direction (SD) of the sealing tool (100). The invention also relates to an apparatus (300) for sealing two sheets (200) of the metallized substrate with the sealing tool (100). Further, the invention relates to a packaging (400) for enclosing a substance and a method of producing such packaging (400).

### 1. FIELD OF THE INVENTION

The present invention relates to a sealing tool and a sealing apparatus for sealing sheets of a metallized substrate, such as a metallized plastic or paper material. The invention further relates to a packaging for enclosing a substance and a method for producing such packaging.

### 2. TECHNICAL BACKGROUND

Metallized paper often consists of a paper substrate and a very thin metal layer that is adhered thereto. It is a popular material choice for various packaging applications because this material offers a plurality of advantages, such as providing a barrier against light, oxygen and/or moisture, being durable and having a relatively low weight to area ratio. In addition, it is possible to print on metallized paper without risking the integrity of a product inside the packaging. Furthermore, the material can be produced in compositions that facilitate recycling of the packaging after its use.

Unfortunately, the process of sealing metallized paper between sealing jaws appears to be technically challenging. In particular, it was found that metallized paper packaging is prone to cracking or ripping in areas around the sealing lines of the packaging. This may result from excessive shearing forces being generated by compressing the packaging material between sealing jaws with high pressure. The shearing forces may cause the very thin metal layer of the metallized paper material to tear. Such defects in the packaging are detrimental for storing and protecting the product inside the packaging and thus, reduce the shelf life of the packaged products. The reason for this is that, when the metallized paper is cracked, the barrier becomes inadequate for protecting the packaged product. However, high pressures are often required to provide the packaging with a sealing that is reliable and has a sufficient seal-strength. Thus, the objective of providing the packaging with a strong seal appears to be in contradiction to the objective of ensuring the integrity of the metallized paper material. In addition, it is difficult to detect such cracks without the support of additional test methods (e.g. using light and/or dye).

In the prior art, sealing jaws are provided with a chamfered or a rounded profile. However, it appears that this approach is insufficient to ensure the integrity of the packaging material near the sealing edges. In particular, it was found that during the process of compressing top and bottom half of the packaging between such adapted sealing jaws, sealant/adhesive will collect and solidify inside a cavity, where top and bottom half branch from the sealing edge. Having such hardened substances inside the product space can be problematic as it can act as a wedge that reopens the sealing edges under the impact of product being filled in the packaging. Thus, the reliability of the packaging cannot be improved by applying this approach.

Thus, it is an object of the present invention to provide a sealing tool, a sealing apparatus, a method and a packaging that overcome the known problems of the prior art. In particular, it is an object of the invention to provide a packaging with a seal of high reliability and seal-strength while tears or cracks in an area around the sealing lines can be avoided. Also, it is an object of the present invention to avoid an excessive sealing pressure during sealing in order to eliminate material damaging sharing stress on the metallized layer while maintaining the seal-strength of the sealing in the packaging.

These and other objects, which become apparent upon reading the description, are solved by the subject-matter of the independent claims. The dependent claims refer to preferred embodiments of the invention.

### 3. SUMMARY OF THE INVENTION

A first aspect of the invention relates to a sealing tool having a sealing surface for sealing at least two sheets of a metallized substrate, such as a metallized paper material or a metallized plastic material, with a sealing edge together with a sealing tool counterpart being arranged opposite to the sealing tool with respect to the sheets to be sealed. The sealing surface comprises a plurality of sealing sections that all face in (towards) the same sealing direction (also referred to as “sealing direction of the sealing tool”). The sealing surface has a sealing width (also referred to as “sealing tool width”), which extends orthogonally or transversely to the sealing direction from an outer sealing tool side to an inner sealing tool side. The sealing sections are arranged (laterally) side by side in a stepwise manner so that, from the outer sealing tool side to the inner sealing tool side, every sealing section is offset from its neighbouring sealing section in a direction opposite to the sealing direction of the sealing tool.

In other words: a sealing tool is provided that comprises a particularly designed sealing surface. The “sealing surface” may be understood, for example, as the surface that contacts at least one of the sheets during a sealing process. For example, in the sealing process, pressure and/or heat may be applied to the sheets to form a bond between the sheet materials. The sealing surface is suitable for sealing sheets of a metallized substrate, such as metallized paper or plastic material sheets, in cooperation with a sealing tool counterpart, which is arranged opposite to the sealing tool with respect to the sheets to be sealed, with a sealing edge. As a “sealing edge” may be understood, for example, a section of the sealed sheets, in which bonding (induced by sealing with the sealing tool) between the sheets exists. For example, the sealing edge may extend longitudinally and transversely. The sealing surface comprises a plurality of sealing sections that all face in a (single) sealing direction. For example, sealing sections may be areas or parts of the sealing surface that may be configured to provide a sealing with specific characteristics. The sealing direction is the same for all sealing sections. Therein, the “sealing direction” may be understood, for example, as a direction, in which the sealing surface is effective for bonding the sheets. For example, the sealing tool as well as the sealing tool counterpart may comprise their own “sealing direction”, along which bonding is effected. The sealing surface extends (orthogonally or) transversely to the sealing direction from an outer sealing tool side to an inner sealing tool side with a sealing width. The “sealing width” may be understood as (preferably the shortest) linear extent of the sealing surface from side to side along the specified direction. The expressions “inner sealing tool side” and “outer sealing tool side” may illustrate, for example, the sealing tool's orientation in operation with respect to a sealed packaging. The sealing sections are arranged (laterally) side by side in a stepwise manner so that, from the outer sealing tool side to (towards) the inner sealing tool side, every sealing section is offset from its neighbouring sealing section in a direction opposite to the sealing direction of the sealing tool. This may mean, for example, that the sealing surface is formed by sealing sections that are arranged in series and in a manner of resembling steps. For example, each sealing section may form a plateau and/or may have a constant distance from a reference plane in a widthwise direction. For example, the abutting surfaces of the two sheets may define the reference plane. With each sealing section closer to the outer sealing tool side, the distance of the respective sealing section to the reference plane may increment.

Thereby, it is possible to stepwise reduce the compression, which is applied onto the metallized substrate by bringing the sheets together for creating the sealing edge, by arranging some of the sealing sections gradually further away from certain areas of the sheet. This allows avoiding that sections of the sealing edge near a product space of the packaging are subjected to high levels of shearing stress during the sealing process. Thus, rupture or tearing of the sheet material can be avoided in these particularly pressure sensitive and for product integrity important areas. Also, the configuration of the sealing tool facilitates that sections of the sealing edge further afield from the product space can be still subjected to levels of compression that are required for forming a strong seal. Thus, the invention allows bringing the requirements of seal-strength and barrier integrity in agreement with each other. Moreover, changing the offset in a stepwise manner overcomes the undesired formation of wedge-shaped cavities and/or solidified material along the sealing edges. Instead, a flat (and, when seen in the width direction, rectangular) surface may be formed. Thus, the known problems of the prior art can be overcome with the sealing tool of the present invention.

According to a preferred embodiment, a transition section between two neighbouring sealing sections may extend parallel to the sealing direction of the sealing tool.

Thus, unlike solutions known from the prior art, where sealing parameters may change constantly, this configuration allows to cause locally an abrupt change in the amount of pressure and/or temperature being applied to the sheets in the sealing process. Hence, the seal-strength of the sealing edge can be modified locally in a stepwise manner so that local zones of varying seal-strength are formed.

According to a further preferred embodiment, the step heights of the sealing sections may be all identical or different from each other. Preferably, the step heights of the sealing sections may gradually increase or decrease from the outer sealing tool side to the inner sealing tool side. Preferably, the step height of one (or some or all) of the sealing sections may be 10%, 20%, 30%, 40%, 50%, 60%, 70%, 80%, 90% or 100% of the overall thickness of the sheets to be sealed. Alternatively or additionally, the step heights of the sealing sections may be each in a range of 10-100% of the overall thickness of the sheets to be sealed. Thus, in some cases, the step height may be the same as the overall thickness of the sheets. More preferred, the step heights of the sealing sections may be in a range of 10-90%, 10-80%, 10-70%, 10-60%, 10-50%, 10-40%, 10-30%, 10-20%, 20-100%, 20-90%, 20-80%, 20-70%, 20-60%, 20-50%, 20-40%, 20-30%, 30-100%, 30-90%, 30-80%, 30-70%, 30-60%, 30-50%, 30-40%, 40-100%, 40-90%, 40-80%, 40-70%, 40-60%, 40-50%, 50-100%, 50-90%, 50-80%, 50-70%, 50-60%, 60-100%, 60-90%, 60-80%, 60-70%, 70-100%, 70-90%, 70-80%, 80-100%, 80-90%, or 90-100% of the overall thickness of the sheets to be sealed. Most preferred, the step heights of the sealing sections may be in a range of 30-70% or 25-75% of the overall thickness of the sheets to be sealed.

Thereby, a height of an individual sealing section with respect to sheet material can be defined. Thus, by changing this parameter the later seal-strength of an area of the sealing edge can be influenced. Hence, it is possible to adapt the geometry of the sealing tool to the requirements of the application. For example, certain materials may require certain pressure levels, or a certain seal-strength may be needed at a certain location.

According to a preferred embodiment, the step widths of the sealing sections may be all identical or different from each other. Preferably, the sealing sections may be gradually increase or decrease from the outer sealing tool side to the inner sealing tool side. Preferably, the step widths of one (or some or all) of the sealing sections may be 10%, 20%, 30%, 40%, 50%, 60%, 70%, 80%, or 90% of the sealing width. Alternatively or additionally, the step widths of the sealing sections may be each in a range of 20-80% of the sealing width. More preferred, the step widths of the sealing sections may be in a range of 10-90%, 10-80%, 10-70%, 10-60%, 10-50%, 10-40%, 10-30%, 10-20%, 20-80%, 20-70%, 20-60%, 20-50%, 20-40%, 20-30%, 30-70%, 30-60%, 30-50%, 30-40%, 40-60%, or 40-50% of the sealing width.

Thereby, a width of an individual sealing section can be defined. Thus, by changing this parameter the size of an area within the sealing edge having a particular seal-strength can be modified. Hence, it is possible to adapt the geometry of the sealing tool to the requirements of the application. For example, certain materials may require certain pressure levels or a certain seal-strength may be needed for a certain extent in the packaging.

According to a further preferred embodiment, the sealing surface may directly merge into an inner side surface extending parallel to the sealing direction of the sealing tool at the inner sealing tool side. Thereby, preferably, the sealing surface may form a sharp inner edge, preferably such that the sealing surface and the inner side surface are joined at a right-angle.

By immediately and/or abruptly (i.e. “sharp”) changing the course of the sealing surface at the transition of the sealing surface to the inner side surface, it can be ensured that wedge-shaped cavities are not formed and/or solidified material does not accumulate along the sealing edge. Instead, a flat surface may be formed. Also, it can be ensured that the sealing surface abruptly changes from contacting the sheets to not contacting the sheets at all. Thereby, the integrity of the metallized substrate can be improved as no (or fewer) shearing forces can be generated in such non-contact areas.

According to a preferred embodiment, the sealing surface may comprise a surface texture that may be smooth and preferably even. Alternatively, the surface texture may be structured or contoured. Therein, the sealing surface and/or the surface texture may preferably comprise a seal pattern. For example, the seal pattern may be a diamond-pattern, a waffle-pattern, a line-pattern or a groove-pattern. Preferably, the sealing sections may be integrally formed with each other. Alternatively, the sealing sections may be formed by separate elements.

Thereby, it is possible to compress the sheets uniformly during the sealing process. Also, the sealing tool is versatile as it is usable in various sealing and packaging applications.

According to a further preferred embodiment, the sealing tool may be a bar sealer. For example, the sealing tool may be an I-bar sealer or a L-bar sealer. Alternatively, the sealing tool may be a roller sealer. It is also conceivable that the sealing tool may comprise two I-bar sealers that may be preferably provided integrally with each other and/or that may be preferably be provided for consecutive sealing of multiple packages.

Thus, standard elements of sealing machinery can be used for realising the invention. Thus, costs can be saved, and the invention is compatible with commonly known sealing systems. A further advantage of using a roller seal as the sealing tool may be that it facilitates to move the sheets through the system. Bar sealers provide the advantage of being less complex and of providing reliably good sealing quality.

A further aspect of the present invention relates to a sealing apparatus for sealing two sheets of a metallized substrate, such as a metallized paper material or a metallized plastic material, with a sealing edge. The sealing apparatus comprises a sealing tool as described above. The sealing apparatus comprises further a sealing tool counterpart having a counterpart sealing surface and being arranged opposite to the sealing tool so that their sealing surfaces are facing each other for sealing the sheets of metallized substrate therebetween.

Thereby, all advantages and benefits described above for the sealing tool can be derived. In addition, it is possible to provide the sealing tool with a counterpart in a manner that facilitates to seal sheets of metallized substrate in an advantageous manner.

According to a preferred embodiment, the counterpart sealing surface may be oriented orthogonal to the sealing direction of the sealing tool. Alternatively or additionally, the counterpart sealing surface may be parallel to the sealing surface of the sealing tool. Preferably, the counterpart sealing surface may extend in a single plane. For example, the counterpart sealing surface may be a machine table.

Preferably, the counterpart sealing surface may be oriented in a counterpart sealing direction. For example, sealing on the counterpart sealing surface may be effected in this counterpart sealing direction. The counterpart sealing direction may be preferably parallel and preferably directed opposite to the sealing direction of the sealing tool.

Thereby, it is possible to effect sealing in an effective manner as the two surfaces are directly facing each other so that sealing forces can be applied directly and in a defined manner onto the metallized substrate.

According to a further preferred embodiment, the sealing tool counterpart may be the above described sealing tool. Therein, the sealing tools may preferably be identical. Preferably, the sealing width of both sealing tools may be oriented in the same manner. For example, both sealing tools may be oriented with their outer sealing tool side and inner sealing tool side in the same manner. Preferably, the two sealing surfaces may be arranged distant from each along the sealing direction of at least one of the sealing tools and/or such that their outer sealing tool side and inner sealing tool side may be flush or aligned with respect to each other when seen along the sealing direction of one of the respective sealing tools. Preferably, the sealing direction and the counterpart sealing direction may be parallel and/or opposite to each other.

Thereby, it is possible to subject the sheets from both sides with the same relief structure (as delimited by both of the sealing surfaces), which results in good sealing quality and material integrity on both sides of the so sealed packaging.

According to a preferred embodiment, the sealing apparatus may further comprise a heating element for heating at least the sealing surface of the sealing tool. Alternatively or additionally, the sealing apparatus may further comprise a heating element for heating at least the counterpart sealing surface to apply heat sealing.

By applying heat during the sealing process, it is possible to improve the versatility of the sealing apparatus as more material combinations can be used and additional sealing applications can be supported. In addition, the application of heat may be beneficial for maintaining material integrity during the sealing process as the metallized substrate may become more flexible.

According to a further preferred embodiment, the sealing apparatus may further comprise an actuator for moving the sealing tool and the sealing tool counterpart relative to each other. Preferably, the relative movement may be a translational movement parallel to the sealing direction of the sealing tool to adjust the distance between the facing sealing surfaces. Alternatively or additionally, the relative movement may preferably be a rotational movement about a rotational axis, which may be orthogonal to the sealing direction of the sealing tool and/or which may be parallel to the sealing width, in case the sealing tool and/or the sealing tool counterpart being provided as a roller sealer.

Thereby, it is possible to automate the process and to move the respective elements of the sealing apparatus relative to each other. In addition, it is possible to incorporate the concepts of the invention in established systems and machinery of the prior art.

A further aspect of the present invention relates to a method of producing a packaging for enclosing a substance. The method comprises the step of providing a substance to be packed. At least two sheets of a metallized substrate, such as a metallized paper material or a metallized plastic material, are provided in an overlapping manner to provide a receiving section for the substance therebetween. The sheets are sealed with a sealing edge so as to seal the substance in the receiving section. The sealing edge comprises a plurality of adjoining sealing areas. Therein, the seal-strength of neighbouring sealing areas gradually (i.e. in a stepwise manner; staggered) decreases in a direction transverse of (orthogonal to) the sealing edge towards the receiving section.

According to a preferred embodiment, the step of sealing may be performed with a sealing apparatus as described above. According to a further preferred embodiment, the step of sealing may be performed simultaneously or successively with sealing pressures gradually increasing from the sealing area, which is closest to the receiving section, to the sealing area, which is most distant to the receiving section. Therein, the sealing pressures may preferably be parallel to each other and more preferred orthogonal to the sheets to be sealed.

By following this method or preferred embodiments thereof, the same advantages and benefits can derived as described above for the sealing tool and the sealing apparatus.

In particular, it can be achieved that the seal-strength is maintained on one side at a high level while a seal with reduced seal-strength is provided at an (laterally) opposite side thereof. Thereby, a reduction of the risk of creating cracks and/or tearing of the metallized substrate can be derived for an area near/around the sealing edge.

Generally, the substance may be understood, for example, as any type of (solid, liquid, at least partially soluble and/or percolate-able) matter of a particular or definite chemical constitution. Examples for substances may be food products, such as coffee powders, dairy powders, tea leaves or chocolate but also cereals or other dried food products. However, this enumeration is not complete and also other substances that are not food products and/or that are not solid, such as liquids or pastes may be used as the substance.

Seal-strength can be measured in different tests and is specified, for example, in industrial norms such as ASTM F88. For example, one of the tests used to determine the seal-strength relates to testing the seal's tensile strength while other tests relate to burst testing.

Reduced seal-strength may be understood, for example, as a seal that has a strength either within a user defined minimum of seal-strength or that at least may be still considered as sealing due to existing material bonds.

According to a preferred embodiment, the step of sealing may be performed by heat sealing. Preferably, heat sealing may be performed with a heating element for heating at least the sealing surface of the sealing tool and/or the counterpart sealing surface of the sealing tool counterpart. Alternatively, the step of sealing may be performed by cold sealing. Therein, preferably prior to cold sealing, a sealant may be applied onto at least one of the sheets. Preferably, at least at an area forming the sealing edge after sealing may be provided with the sealant.

Thereby, the sealing quality can be improved, and more material combinations can be used for the sealing process.

According to a further preferred embodiment, the at least two sheets of metallized substrate, such as a metallized paper material or a metallized plastic material, may be integrally formed as a single sheet element. Therein, the single sheet may preferably be folded to provide the sheets in the overlapping manner.

Thereby, it is possible to reduce the amount of material and energy that is used for producing the packaging as one of the packaging edges can be formed bythe overlapping section. Moreover, it is possible to apply the method in vertical and/or horizontal form filling machines.

According to a preferred embodiment, the step of sealing may be followed by a finish sealing step for applying sealing pressure only on at least part of at least one of the sealing areas with higher or highest seal-strength.

Thereby, it is possible to keep airways open in the packaging during the filling process while providing already a seal sufficient for the filling process. At the end of the filling process, it is possible to close this airway through sealing an area that is less susceptible for cracking due to the pre-sealing process but still requires high sealing pressures.

A further aspect of the present invention relates to a packaging produced with the method of the invention.

A further aspect of the present invention relates to a packaging, wherein the packaging is made of at least two sheets of a metallized substrate, such as a metallized paper material or a metallized paper material, arranged in an overlapping manner and sealed with a sealing edge. The sealing edge comprises a plurality of adjoining sealing areas. The seal-strength of neighbouring sealing areas gradually (in a stepwise manner) decreases in a direction transverse of the sealing edge towards the receiving section. Preferably, the packaging may be produced with the above described method. Preferably, the packaging may be sealed for enclosing a substance in a receiving section between the overlapping sheets.

The same advantages and benefits can be derived for the packaging as described above for the sealing tool, the sealing apparatus and the method. In addition, a packaging can be provided that has an improved shelf life and reliability of the packaging. Moreover, tests for detecting cracks or tearing in packaging can be avoided as the risk is reduced.

Preferably, the metallized substrate may be a metallized paper material. Alternatively or additionally, the metallized substrate may be a metallized plastic material, such as metallized Polyethylene terephthalate (PET), Polypropylene (PP), or Polyethylene (PE).

According to a further preferred embodiment, the metallized substrate (e.g. metallized paper or plastic material) may be recyclable. Alternatively or additionally, the metallized substrate (e.g. metallized paper or plastic material) may comprise a multi-layered structure. Preferably, one of the layers may comprise a fibre-based paper material. Alternatively or additionally, one of the layers may comprise a metal coating, such as Aluminium. Alternatively or additionally, one of the layers may comprise a sealant and/or a plastic material. Preferably, the (multi-layer flexible) metallized substrate, such as metallized paper material or metallized plastic material, may have an overall thickness in the range of 30-150 gsm.

Therein, the expression “recyclable” may be understood as, for example, as a material that can be reused entirely for a new product or purpose after having been treated mechanically or chemically using an industrial or natural process. For example, the metallized substrate used in the invention may be collected after usage and may be mixed with water and chemicals to break it down. It is heated up and broken up, e.g. into strands of cellulose. Metal and plastic coatings as well as ink may be removed as long as they do not exceed a certain amount, for example by filtering. For example, to recycle metallized paper material successfully, the amount of a metal or a plastic coating on the recycled material may be between 5% to 10% of its total weight. Alternatively, the amount of metal or polymer content in the recyclable material may be between 5% to 10% of its total weight. Alternatively or additionally, the metallized substrate may be considered recyclable, for example, with the layer comprising metal having a thickness in a range of 20 to 500 nm, and/or the layer comprising sealant having a grammage in a range of 1.5 to 10 g/m². Preferably, the metallized substrate, such as metallized paper material or metallized plastic material, may comprise (at least) one of these recyclable configurations.

Thereby, it is possible to provide a packaging from a versatile and ecological advantageous packaging material.

### 4. BRIEF DESCRIPTION OF DRAWINGS

Further features, advantages and objects of the invention will become apparent for the skilled person when reading the following detailed description of embodiments of the invention and when taking in conjunction with the figures of the enclosed drawings.

In case numerals have been omitted from a figure, for example for reasons of clarity, the corresponding features may still be present in the figure.

FIG. 1 shows a schematic sideview of an embodiment of a sealing tool according to the invention and an embodiment of a sealing apparatus according to the invention.

FIG. 2 shows a schematic sideview of a further embodiment of the sealing tool according to the invention.

FIGS. 3A and 3B show further embodiments of the sealing tool and the sealing apparatus according to the present invention.

FIGS. 4A to 4C show perspective simplified views of further embodiments of the sealing tool according to the present invention.

FIGS. 5A and 5B show perspective simplified views of further embodiments of the sealing tool according to the present invention.

FIG. 6A shows a perspective view of a further embodiment of the sealing tool and the sealing apparatus according to the present invention.

FIG. 6B shows a top view of the sealing tool and the sealing apparatus of FIG. 6A.

FIG. 7A shows a perspective view of a further embodiment of the sealing tool and the sealing apparatus according to the present invention.

FIG. 7B shows a top view of the sealing tool and the sealing apparatus of FIG. 7A.

FIG. 8 shows a perspective view of an embodiment of a packaging according to the present invention.

FIG. 9A shows a sealing curve, force (N) vs displacement (mm) for metallized papers sealed between jaws with no step.

FIG. 9B shows a sealing curve, force (N) vs displacement (mm) for metallized papers sealed between jaws with a step on the lower jaw.

### 5. DETAILED DESCRIPTION

The Figures show different views and aspects of different embodiments of the invention.

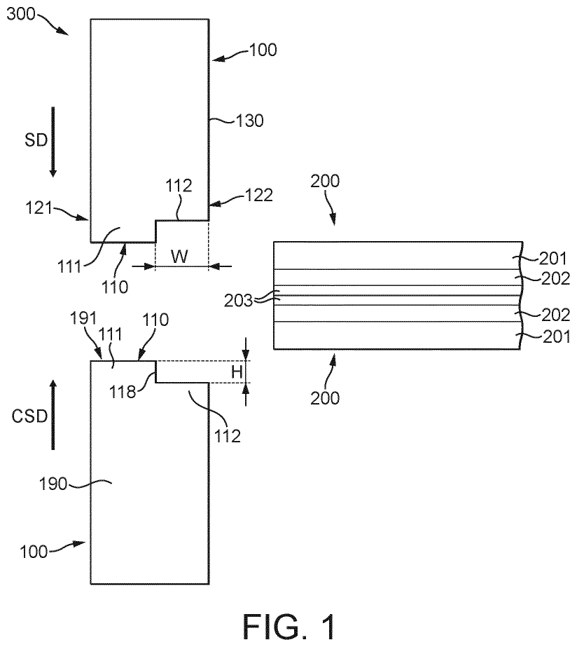

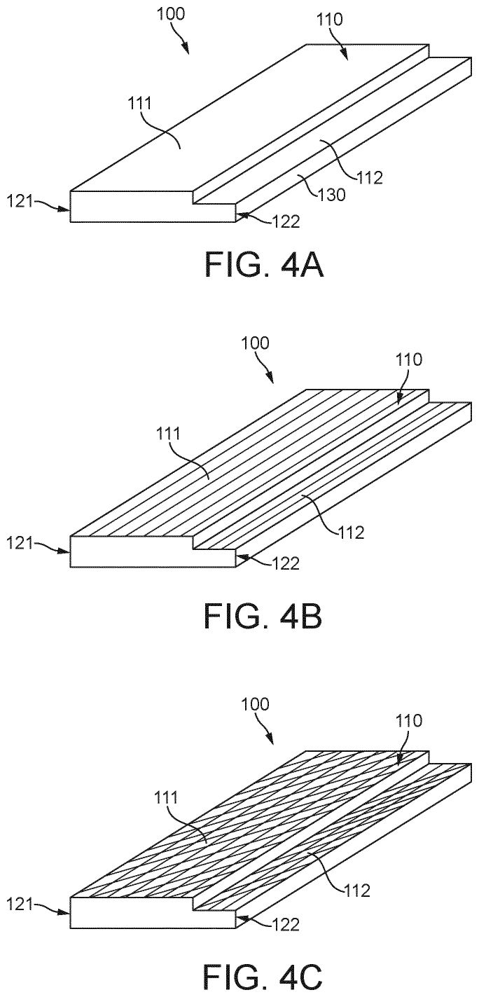

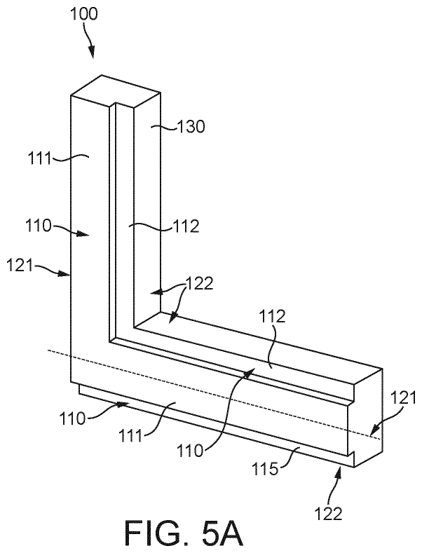

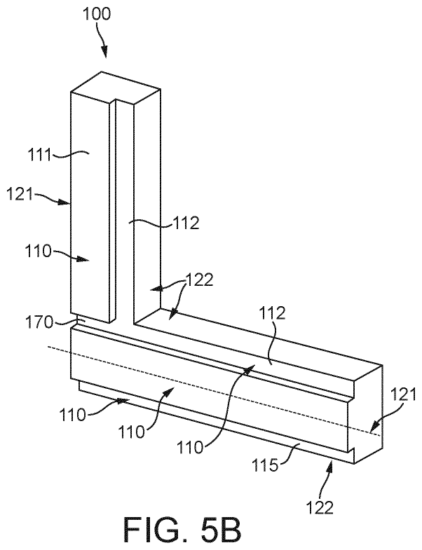

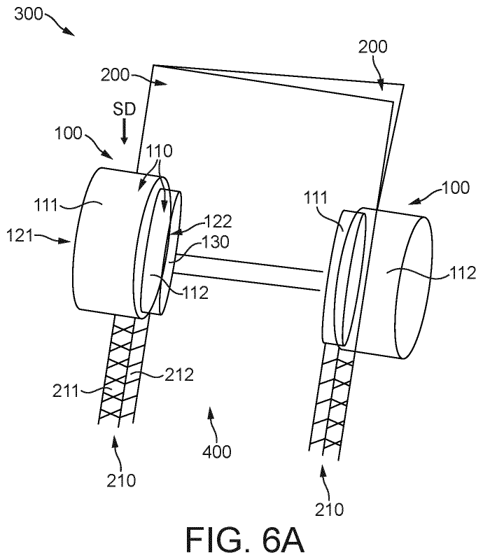

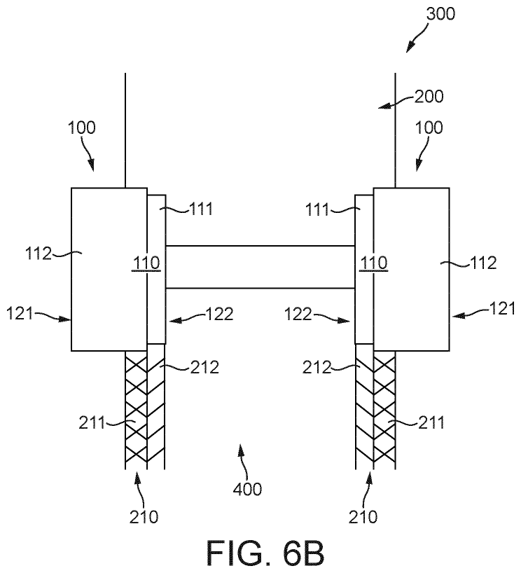

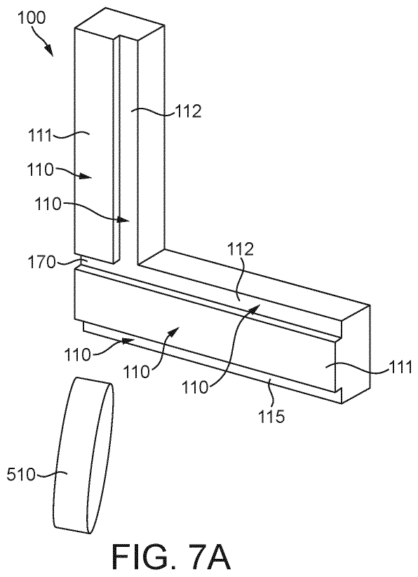

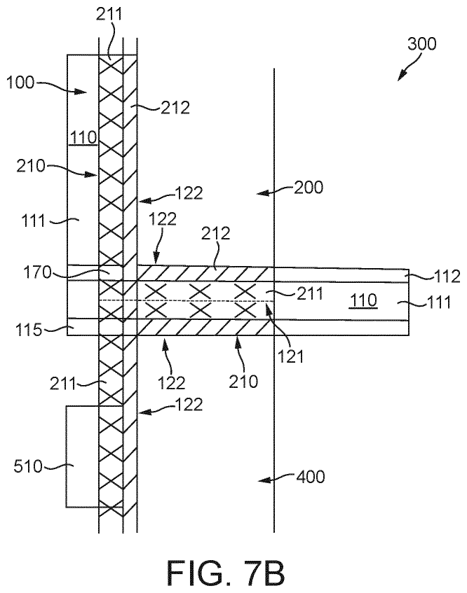

A first aspect of the present invention relates to a sealing tool 100. The sealing tool 100 is exemplarily illustrated in FIGS. 1 to 7. For example, the sealing tool 100 may be a bar sealer, such as an I-bar sealer (FIG. 4) or an L-bar sealer (FIGS. 5 and 7) as shown in the Figures. Alternatively, it is also conceivable that the sealing tool 100 may be a roller sealer as exemplarily illustrated in FIGS. 6A and 6B. The sealing tool 100 may be suitable for sealing of packaging used in food products.

The sealing tool 100 has a sealing surface 110 for sealing at least two sheets 200 of a metallized substrate, such as a metallized paper material, with a sealing edge 210. In the Figures, the metallized substrate is exemplarily illustrated as metallized paper material. However, the Figures are also applicable to the metallized substrate being a metallized plastic material, for instance.

The sealing surface 110 may be adapted to cooperate for the sealing process with a sealing tool counterpart 190 that is arranged opposite to the sealing tool 100 with respect to the sheets 200. This is exemplarily illustrated in FIGS. 1 to 7. The sealing surface 110 may be an effective area of the sealing tool 100 and/or an area that is active during the sealing process. Thus, the sealing surface 110 may be a surface that could interact with the sheets 200 in the sealing process. Preferably, the sealing surface 110 may be adapted to effect sealing between the sheets 200 by applying heat and/or pressure onto the sheets 200. The sealing surface 110 may be provided in various configurations. For example, the sealing surface 110 may have a surface texture that is even and preferably smooth, such as exemplarily illustrated in FIGS. 4A and 5 to 7. However, it is also conceivable to provide the sealing surface 110 with a surface texture that may be structured or contoured as shown in FIGS. 4B and 4C. Therein, the sealing surface 110 may comprise a seal pattern like a line or groove pattern (FIG. 4B) or a diamond or waffle pattern (FIG. 4C). However, also other patterns suitable for providing a defined sealing pattern onto metallized substrates, such as metallized paper or plastic material, may be used.

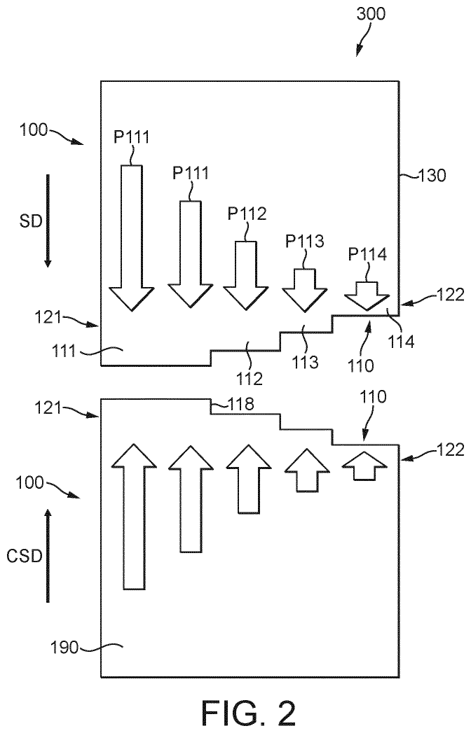

The sealing surface 110 comprises a plurality of sealing sections 111-115 (this reference sign indication is used to simplify the detailed enumeration: 111, 112, 113, 114, 115) that are all facing in a sealing direction SD, which is the same for each of the sealing sections 111-115. This is exemplarily illustrated in all Figures and highlighted in FIG. 2. There is no limitation in the number of sealing sections 111-115, which the sealing surface 110 may comprise. For example, FIGS. 1 to 7 show the sealing tool 100 with at least two sealing sections 111, 112. However, in FIG. 2 the sealing surface 110 is exemplarily illustrated with at least four sealing sections 111-114.

As exemplarily shown in FIGS. 1 to 3 and 6 to 7, the sealing direction SD of the sealing tool 100 may be a direction, in which the sealing surface 110 effects sealing of the sheets 200. Preferably, the sealing direction SD may be parallel to a surface normal of the sheets 200. The sealing sections 111-115 may be parts or portions of the sealing tool 100 that form areas or segments of the sealing surface 100. The sealing surface no may be delimited by the sealing sections 111-115, preferably such that a continuous surface or area may be formed thereby. More preferred, the sealing surface no may be continuous when seen in a direction opposite to the sealing direction SD of the sealing tool 100. The sealing sections 111-115 may be (at least partially) integrally formed with each other such as illustrated exemplarily in FIGS. 1 to 5 and 7. Alternatively, the sealing sections 111-115 may be (at least partially) formed by separate elements such as in FIG. 6, where two pairs of separate rolls are illustrated, which each form together an individual roller seal as the sealing tool 100.

The sealing surface no may have a sealing width extending orthogonally or transversely to the sealing direction SD from an outer sealing tool side 121 to an inner sealing tool side 122. This is exemplarily illustrated in FIGS. 1 to 7. As indicated in these Figures, the inner sealing tool side 122 may be a side, which is closest to a portion of the sealed sheets 200 that is intended for receiving a product.

The sealing sections 111-115 are arranged side by side. The sealing sections 111-115 may be arranged in immediate and/or direct succession of each other, preferably such that two neighbouring sealing sections 111-115 abut onto each other. This is exemplarily illustrated in FIGS. 1 to 7.

Further, the sealing sections 111-115 are arranged in a stepwise manner so that, from the outer sealing tool side 121 to the inner sealing tool side 122, every sealing section 111-115 is offset from its neighbouring sealing section 111-115 in a direction opposite to the sealing direction SD of the said sealing tool 100. This is exemplarily illustrated in FIGS. 1 to 7. Therein, the sealing sections 111-115 are exemplarily shown with a staggered configuration between the outer sealing tool side 121 and the inner sealing tool side 122.

FIGS. 5 and 7 illustrate exemplarily an embodiment of the sealing tool 100 that may be used for consecutive sealing of (multiple) packaging. Therein, the sealing tool 100 may comprise a profile that facilitates such processing by providing the sealing surface 110 with a first sealing section 11 that is sandwiched between two further sealing sections 112, 115. A broken line indicates the position of the (imaginary) outer sealing tool side 121 in the middle of this arrangement. Thereby, it is possible to use the sealing tool 100 for sealing one of two consecutive packages with the sealing edge 210 at the top and the other one at the bottom, all in a single sealing step. Thus, the L-shaped sealing bar may be considered, for example, an integral connection of two I-shaped sealing bars.

Preferably, a transition section 118 between two neighbouring sealing sections 111-115 may extend parallel to the sealing direction SD. This is exemplarily illustrated in FIGS. 1 and 2. It is also conceivable that the transition section 118 may have a modified form, such as comprising a rounding or chamfer, which, for example, may be generated in a micro-rounding process.

The sealing surface 110 may, at the inner sealing tool side 122, directly merge into an inner side surface 130 extending parallel to the sealing direction SD to form a sharp inner edge. This is exemplarily illustrated in FIGS. 1 to 7.

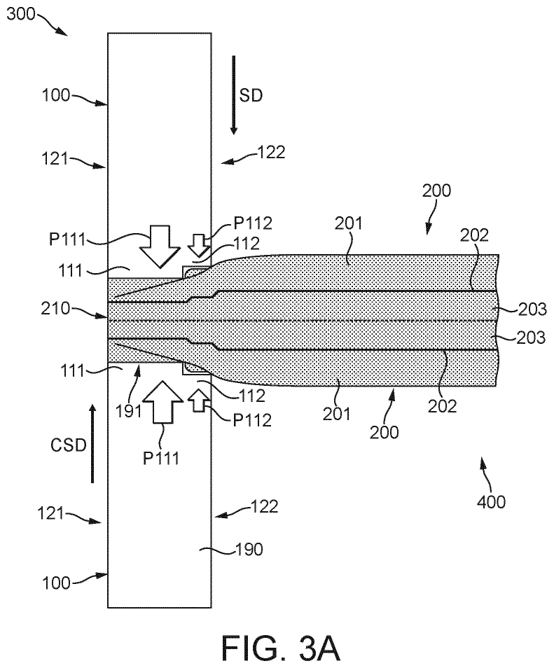

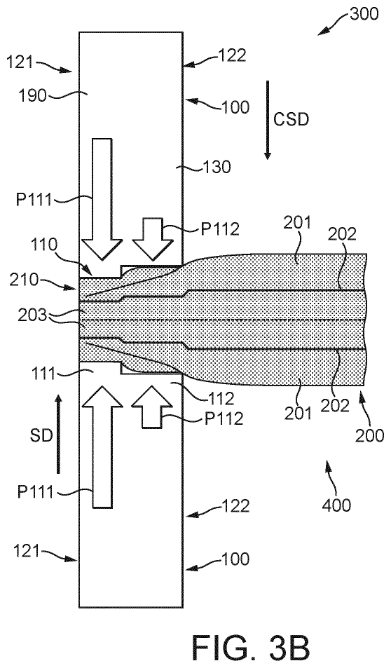

In FIGS. 2 and 3, it is exemplarily displayed how the shape of the sealing surface 110 influences compression of the sheets 200 during the sealing process. For example, levels of pressures P111-P114, which may result from bringing the sealing tool 100 and/or the sealing tool counterpart 190 closer to each other for sandwiching the sheets 200, may correlate (directly) with the offset of the sealing sections 111-114 (and 115, which is not shown in these Figures). Therein, it was found that the levels of the pressures P111-P114 decrease with increasing offset. Accordingly, the sheets 200 may be subjected to reduced compression within the respective sealing sections 112-114 in comparison to the sealing section in nearest to the outer sealing tool side 121. As exemplified in FIGS. 3, after sealing the sealing edge 210 may comprises one zone of strong sealing tool contact and additional zones of reduced sealing tool contact. The use of the sealing tool 100 with a sharp inner edge formed by the inner side surface 130 extending parallel to the sealing direction SD may facilitate that the zone with reduced sealing tool contact abruptly changes into a no sealing tool contact zone. Thereby, it can be achieved that the metallized substrate (e.g. a metallized paper or plastic material) remains undamaged from the sealing process.

The step heights H of the sealing sections 111-115 may be all identical (e.g. FIG. 1) or different from each other (e.g. FIG. 2). For example, the step heights H may gradually increase or decrease from the outer sealing tool side 121 to the inner sealing tool side 122. Preferably, the step height H of one of the sealing sections 111-115 with respect to its neighbour may be considered its (relative) offset from that sealing section 111-115. Preferably, the step height H of the sealing section 111-115 nearest to the inner sealing tool side 122 may be configured such that material is still brought in close enough contact for sealant to interact. Alternatively or additionally, the step heights H of the sealing sections 111-115 may be each in a range of 10-100%, more preferred in a range of 30-70%, of the overall thickness of the sheets 200 to be sealed. Preferably, the overall thickness of the sheets 200 may be around 10 micrometres to 1000 micrometres. More preferred, the step heights H may be in a range between 100 micrometres and 300 micrometres.

The step widths W of the sealing sections may be all identical (e.g. FIG. 1) or different from each other (e.g. FIGS. 2 and 3). Preferably, the step widths may gradually increase or decrease from the outer sealing tool side 121 to the inner sealing tool side 122. Alternatively or additionally, the step widths W of the sealing sections 111-115 are each in a range of 20-80% of the (overall) sealing width. For example, the step width W may be in a range between 1 mm and 20 mm. More preferred, the step widths W may be in a range between 5 mm and 20 mm. Therein, for example, the overall sealing width may be 25 mm. It is also conceivable that the overall sealing width may be the same as the width of the sealing tool 100.

A further aspect of the present invention relates to a sealing apparatus 300 for sealing (at least) the two sheets 200 of metallized substrate, such as a metallized paper or plastic material, with the sealing edge 210. The sealing apparatus 300 comprises the above described sealing tool 100. This is exemplarily illustrated in FIGS. 1 to 3, 6 and 7. The sealing apparatus 300 may be an individual sealing machine or it may be part of a vertical or horizontal form filling machine. The sealing apparatus 300 may be adapted to seal more than two sheets 200 of metallized substrate, such s a metallized paper or plastic material, together.

Moreover, the sealing apparatus 300 comprises the sealing tool counterpart 190. The sealing tool counterpart 190 has a counterpart sealing surface 191 and is arranged opposite to the sealing tool 100 so that their respective sealing surfaces 191, 110 are facing each other for sealing the sheets 200 of metallized substrate therebetween. Various arrangements of the sealing counterpart 190 with respect to the sealing tool 100 are conceivable. For example, the sealing counterpart 190 may form the top part of a sealing jaw while the sealing tool 100 may form the bottom part thereof (see FIG. 3B) or vice versa (see FIGS. 1 to 3A).

The sealing tool counterpart 190 may have a counterpart sealing direction CSD, in which preferably sealing is effected with the counterpart sealing surface 191. This is exemplarily illustrated in FIGS. 1 to 3. The counterpart sealing direction CSD and the sealing direction SD may be parallel and preferably directed opposite to each other as exemplarily illustrated in these Figures.

The sealing tool counterpart 190 may be the sealing tool 100. This is exemplarily illustrated in FIGS. 1 to 3. Preferably, the sealing tools 100 may be identical. However, it is also conceivable that the sealing tool counterpart 190 may be different from the sealing tool 100.

Preferably, the counterpart sealing surface 191 may be oriented orthogonal to the sealing direction SD of the sealing tool 100. The counterpart sealing surface 191 may be parallel to the sealing surface 110 of the sealing tool 100. This is exemplarily illustrated in all Figures. Preferably, the counterpart sealing surface 191 may be provided with a (the same) configuration as the sealing surface 110 of the sealing tool 100. The sealing width of the counterpart sealing surface 191 and the sealing surface 110 may be oriented in the same manner. For example, in the Figures, the sealing tool 100 and the sealing tool counterpart 190 may be oriented with their respective inner sealing tool sides 121 and outer sealing tool sides 122 in the same manner. Preferably, the counterpart sealing surface 191 and the sealing surface 110 may be arranged mirror symmetrical (e.g. with respect to the sheets 200). This is exemplarily illustrated in all Figures.

The sealing apparatus 300 may further comprise one or more heating elements (not illustrated) for heating at least the sealing surface 110 of the sealing tool 100 and/or the counterpart sealing surface 191 to apply heat sealing.

The sealing apparatus 300 may further comprise an actuator (not illustrated) for moving the sealing tool 100 and the sealing tool counterpart 190 relative to each other. For example, the actuator may be an electric motor, or a pneumatic or hydraulic cylinder. Preferably, the relative movement may be a translational movement parallel to the sealing direction SD of the sealing tool 100 (or the counterpart sealing direction CSD of the sealing tool counterpart 190) to adjust the distance between the sealing surface 110 and the counterpart sealing surface 191. This is exemplarily illustrated in FIGS. 1 to 3 and 7. Alternatively, the relative movement may be, in case of a roller sealer as the sealing tool 100 and/or as the sealing tool counterpart 190, a rotational movement about a rotational axis being orthogonal to the sealing direction SD of the sealing tool 100 and/or parallel to the sealing width. This is exemplarily illustrated in FIGS. 6 and 7.

A further aspect of the invention relates to a method of producing a packaging 400 for enclosing a substance. The method may be adapted for packaging of food products.

The method comprises the step of providing a substance to be packed. Preferably, the substance may be in a solid state and may comprise various compositions. However, the substance may be packed also in other states of aggregation. The substance may be a food product, such as coffee powder or dairy powder.

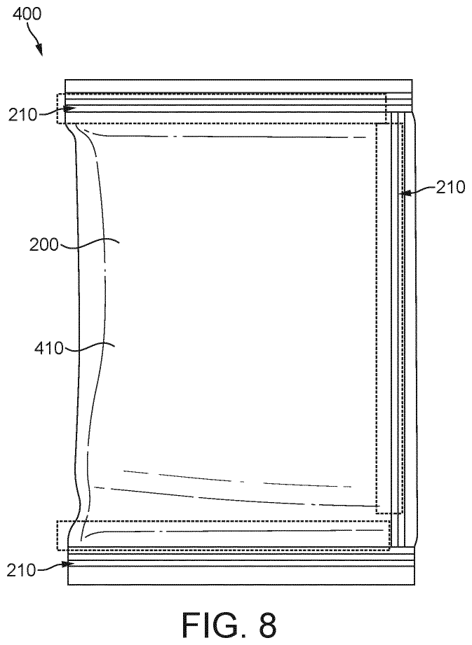

The method comprises further the step of providing at least two of the sheets 200 of metallized substrate, such as a metallized paper or plastic material, in an overlapping manner to provide a receiving section 410 (product space) for the substance therebetween. Preferably, the at least two sheets 200 of metallized substrate (e.g. a metallized paper or plastic material) may be integrally formed as a single sheet element and folded over to provide the sheets 200 in overlapping manner. This is exemplarily illustrated in FIG. 8. However, it is also conceivable that the sheets 200 may be provided as (two) separate sheets.

The sheets 200 of metallized substrate (e.g. of metallized paper or plastic material) may (each) comprise a multi-layered structure. Preferably, the multi-layered metallized substrate may have an overall thickness in the range of 30-150 gsm. This is exemplarily illustrated in FIGS. 1 to 3. Preferably, one of the layers may comprise a fibre-based paper material. For example, in the Figures, a top layer 201 is made of the paper material. The content of the paper material layer may be in the range of 90% to 98% of the total weight of the material. Moreover, another layer may comprise a metal coating, such as Aluminium. For example, in the Figures, an intermediate layer 202 is made of metal. The content of the metal coating may be in the range of 1% to 5% of the total weight of the material. Preferably, the layer comprising the metal may have a thickness in the range of 20 nm to 500 nm. A further layer may comprise a plastic material and/or a sealant. In the Figures, a bottom layer 203 is illustrated as comprising the sealant. The content of the plastic material and/or sealant may be in the range of 1% to 5% of the total weight of the material. Preferably, the layer comprising sealant may have a grammage in the range of 1.5-10 g/m². As illustrated exemplarily, the sheet 200 may be a thin and wide layer or membrane that preferably may extend within a plane. Further, the metallized substrate, such as metallized paper or plastic material, may be configured to be recyclable.

The method comprises further the step of sealing the sheets with the sealing edge 210 to seal the substance in the receiving section 410. Therein, the sealing edge 210 comprises a plurality of adjoining sealing areas 211, 212. The seal-strength of neighbouring sealing areas 211, 212 gradually (in a stepwise manner) decreases in a direction transverse of the sealing edge 210 towards the receiving section 410. This is exemplarily illustrated in FIGS. 6 and 7, where the respective sealing areas 211, 212 are shown with different hatching patterns. Seal-strength levels may be determined with standardized test measures. For example, a comparison of seal-strength levels may be completed by comparing parameters that ensure proper material bonding to maintain integrity of a packaging throughout its shelf-life. For example, tensile strength and burst testing may be completed.

Preferably, the step of sealing is performed with the above described sealing apparatus 300. Alternatively, it is also conceivable that the step of sealing is performed simultaneously or successively with sealing pressures (or sealing compression) Pill-P114 gradually increasing from the sealing area 211, 212 closest to the receiving section 410 to the sealing area most distant to the receiving section 410. Preferably, the sealing pressures P111-P114 may be applied in directions orthogonal to the sheets 200 to be sealed and parallel to each other.

Moreover, the step of sealing may be performed by heat sealing, preferably by use of the heating element. For example, if the sealing apparatus 300 is used, the sealing surface 110 of the sealing tool 100 and/or the counterpart sealing surface 191 may be subjected to heat. Alternatively, it is also conceivable that the step of sealing is performed by cold sealing. Therein, prior to cold sealing, preferably a sealant is applied onto at least one of the sheets 200 at least at an area forming the sealing edge 210 after sealing.

It is also conceivable that the step of sealing is followed by a finish sealing step, in which sealing pressure may be applied only on at least part of at least one of the sealing areas 211, 212 with higher or highest seal-strength. This is exemplarily illustrated in FIG. 7. Therein, the sealing area 211, which has a seal-strength higher than its neighbouring sealing area 212, is subjected to an additional sealing step by finishing roller seal 510. Thereby, a segment of the sealing edge 210, which was not closed during the sealing process due to a gap 170 in the sealing section 11 of the sealing tool 100, can be sealed. Moreover, the finishing roller seal 510 may be used to move the sheets 200 through the sealing apparatus 300. This example of FIG. 7 also illustrates that the sealing apparatus 300 may comprise combinations of roller seals and seal bars.

Moreover, it is also conceivable that the method is used to produce multiple packages in a sequence, e.g. by sealing an endless tube. This is exemplarily indicated in FIGS. 6B and 7B, where two sheets 200 start from the top while a packaging 400 leaves at the bottom.

A further aspect of the invention relates to the packaging 400, which preferably may have been produced by the above described method. FIG. 8 shows an example for the packaging 400. The packaging 400 may be, for example, a pouch, a bag or a stand-up packaging.

The packaging 400 is made of at least two sheets 200 of a metallized substrate, such as a metallized paper or plastic material, which are arranged in an overlapping manner and sealed with the sealing edge 210. Preferably, sealing with the sealing edge 210 is completed to seal a substance in the receiving section 410 between the overlapping sheets 200. The sealing edge 210 comprises a plurality of adjoining sealing areas 211, 212. The seal-strength of the sealing areas 211, 212 gradually (in a stepwise manner) decreases in a direction transverse of the sealing edge 210 towards the receiving section 410.

For example, the packaging 400 may comprise multiple sealing edges 210 that may be provided as longitudinal or transversal seal. The sealing edges 210 may complete enclose the receiving section 410.

An embodiment of the invention provides a packaging (400), preferably produced by a method according to the invention, wherein the packaging (400) is made of at least two sheets (200) of a metallized substrate, preferably a metallized paper material or a metallized plastic material, arranged in an overlapping manner and sealed with a sealing edge (210), preferably to seal a substance in a receiving section (410) between the overlapping sheets (200); wherein the sealing edge (210) comprises a plurality of adjoining sealing areas (211, 212), wherein the seal-strength of neighbouring sealing areas (211, 212) gradually decreases in a direction transverse of the sealing edge (210) towards the receiving section (410). For example the seal strength between two adjoining sealing areas (211, 212) may decrease such that the maximum seal strength in Newtons of one sealing area (212) is between 10 and 80% of the maximum seal strength of the adjoining sealing area (211), for example as measured under test standard ASTM F88. The strength of the seal may for example be measured by a Universal Testing Machine according to ASTM F88 using the “unsupported” method.

By forming the packaging 400 with the sealing tool 100 or apparatus 300 or method of the invention, it may be that the packaging 400 comprises within and near the sealing edges 210 (area indicated by broken line boxes in FIG. 8) three different zones, namely a first zone on the outer edge of the packaging that forms a strong sealing bond between the sheets 200, a second zone, which directly follows the first zone and forms a sealing bond with reduced strength, and a third zone, which follows the second zone and forms a non-contact zone in the receiving section 410. For example, results of tear force measurements may show a stepwise reduction of the tear force that is required for tearing the sealing edge 210 from the first zone (forming the strong sealing bond) towards the third zone (forming the non-contact zone).

### EXAMPLE

Two sheets of metalized paper (metallization layer/paper/heat seal coating) were sealed using sealing jaws modified such that the bottom sealing bar had a step in it, that is to say it had two adjacent sealing sections each with a width of 10 mm. One sealing section was 0.06 mm higher than the other. For comparison, a second sample was prepared with two sheets of the same metalized paper but the sealing was performed by sealing jaws without a step.

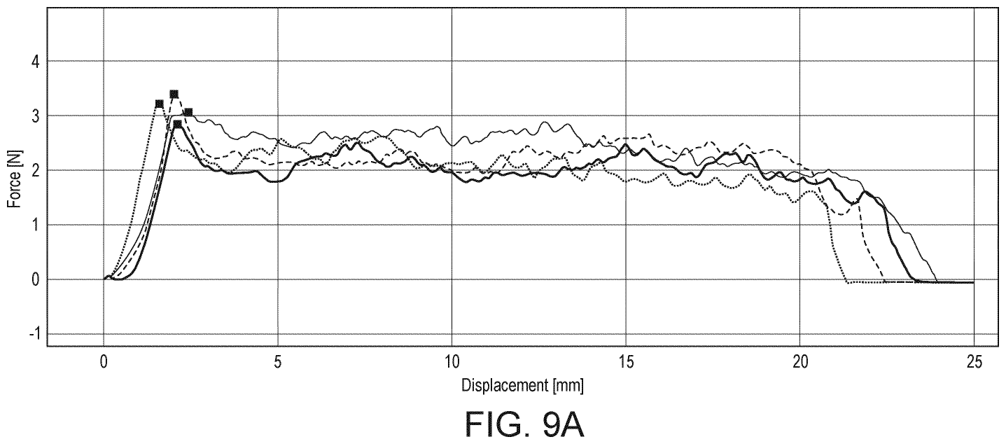

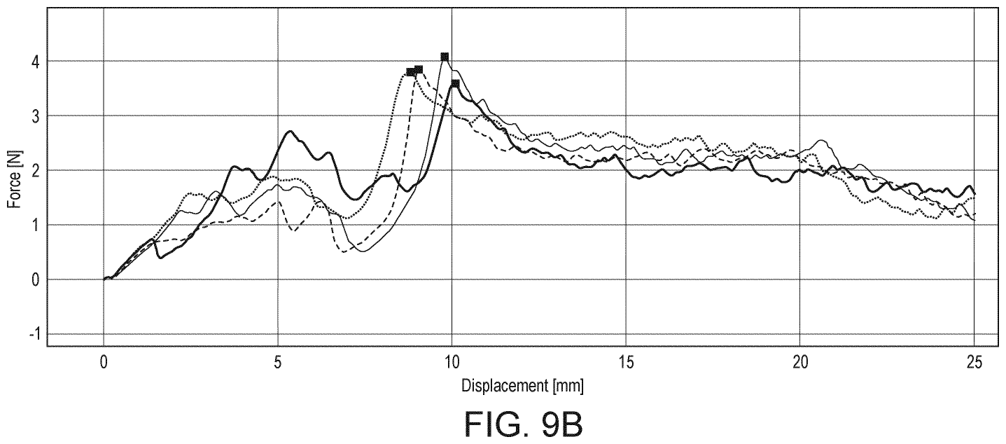

The seal strength of the samples produced with and without the stepped jaws were measured according to ASTM F88 using a universal testing machine (Instron 3365) at a rate of 200 mm/min. Four samples of each type were tested. Each tail of the sample was secured in opposing grips and the seal remained unsupported while the test was being conducted to measure the force required to separate the test strip containing the seal. The results are shown in FIG. 9A (sealed with no step) and FIG. 9B (sealed with a step). FIG. 9A shows a maximum seal strength at an initial peak, with the force as displacement increased remaining essentially constant. The sample manufactured with the stepped sealing jaw however (FIG. 9B) showed a weak seal region with a maximum seal strength around 2N and an adjacent strong seal range with a maximum seal strength around 4N. Examining the metallized papers sealed without a step in the sealing jaws showed cracks adjacent to where the product would be present in the final pack. The metallized papers sealed with a step in the sealing jaws had no cracks adjacent to where the product would be present in the final pack.

The invention is not limited by the embodiments as described hereinabove, as long as being covered by the appended claims. All the features of the embodiments described hereinabove can be combined in any possible way and be provided interchangeably.

1. A sealing tool having a sealing surface for sealing at least two sheets of a metallized substrate with a sealing edge together with a sealing tool counterpart being arranged opposite to the sealing tool with respect to the sheets to be sealed,
the sealing surface comprises a plurality of sealing sections all facing in the same sealing direction,
the sealing surface has a sealing width extending transversely to the sealing direction from an outer sealing tool side to an inner sealing tool side, and
wherein the sealing sections are arranged side by side in a stepwise manner so that, from the outer sealing tool side to the inner sealing tool side, every sealing section is offset from its neighbouring sealing section in a direction opposite to the sealing direction of the sealing tool.

2. The sealing tool according to claim 1, wherein a transition section between two neighbouring sealing sections extends parallel to the sealing direction of the sealing tool.

3. The sealing tool according to claim 1, wherein the step heights of the sealing sections are all identical or different from each other, preferably gradually increase or decrease from the outer sealing tool side to the inner sealing tool side, and
wherein the step widths of the sealing sections are different from each other.

4. The sealing tool according to claim 1, wherein the sealing surface, at the inner sealing tool side, directly merges into an inner side surface extending parallel to the sealing direction of the sealing tool, preferably forming a sharp inner edge, and
the sealing surface comprises a surface texture that is smooth, structured or contoured and preferably comprises a seal pattern such as a diamond-, a waffle-, a line- or a groove-pattern.

5. The sealing tool according to claim 1, wherein the sealing tool is a bar sealer.

6. A sealing apparatus for sealing two sheets of a metallized substrate with a sealing edge, comprising
a sealing tool having a sealing surface for sealing at least two sheets of a metallized substrate with a sealing edge together with a sealing tool counterpart being arranged opposite to the sealing tool with respect to the sheets to be sealed,
the sealing surface comprises a plurality of sealing sections all facing in the same sealing direction,
the sealing surface has a sealing width extending transversely to the sealing direction from an outer sealing tool side to an inner sealing tool side, and
wherein the sealing sections are arranged side by side in a stepwise manner so that, from the outer sealing tool side to the inner sealing tool side, every sealing section is offset from its neighbouring sealing section in a direction opposite to the sealing direction of the sealing tool, and
a sealing tool counterpart having a counterpart sealing surface and being arranged opposite to the sealing tool so that their sealing surfaces are facing each other for sealing the sheets of metallized substrate therebetween.

7. The sealing apparatus according to claim 6, wherein the counterpart sealing surface is oriented orthogonal to the sealing direction of the sealing tool or the counterpart sealing surface is parallel to the sealing surface of the sealing tool.

8. (canceled)

9. The sealing apparatus according to claim 6, further comprising an actuator for moving the sealing tool and the sealing tool counterpart relative to each other.

10. A method of producing a packaging for enclosing a substance, comprising:
providing a substance to be packed;
providing at least two sheets of a metallized substrate in an overlapping manner to provide a receiving section for the substance therebetween;
sealing the sheets with a sealing edge so as to seal the substance in the receiving section, and
wherein the sealing edge comprises a plurality of adjoining sealing areas, wherein the seal-strength of neighbouring sealing areas gradually decreases in a direction transverse of the sealing edge towards the receiving section.

11. (canceled)

12. The method according to claim 10, wherein the step of sealing is performed by heat sealing, preferably by use of a heating element for heating at least the sealing surface of the sealing tool and/or the counterpart sealing surface.

13. The method according to claim 10, wherein the at least two sheets of metallized substrate are integrally formed as a single sheet element and folded to provide the sheets in the overlapping manner.

14. The method according to claim 10, wherein the step of sealing is followed by a finish sealing step for applying sealing pressure only on at least part of at least one of the sealing areas with higher or highest seal-strength.

15. (canceled)
